(19) United States
(12) Patent Application Publication
(10) Pub. No.: US 2005/0239677 A1
(43) Pub. Date: Oct. 27, 2005

(54) Use of new bleach activators in dishwashing detergents

(75) Inventors: Ralf Wiedemann, Griesheim (DE); Harald Magg, Ladenburg (DE); Marcus Guzmann, Leimen (DE); Jurgen Schmidt, Laudenbach (DE); Guido Knuhl, Ladenburg (DE); Laurence Geret, Ludwigshafen (DE)

Correspondence Address: Norris, McLaughlin & Marcus P.A., 18th Floor, 875 Third Avenue, New York, NY, 10022, US

(73) Assignee: Reckitt Benckiser N.V, Hoofddorp (NL)

(21) Appl. No.: 11/108,183

(22) Filed: Apr. 18, 2005

Related U.S. Application Data
(62) Division of application No. 10/343,613, filed on May 12, 2003.

(30) Foreign Application Priority Data
Aug. 4, 2000 (DE) 10038180.4

(51) Int. Cl. C11D 9/42

(52) U.S. Cl. 510/314

(57) ABSTRACT

Use of a composition as a bleach activator in a dishwasher detergent composition, said composition being obtainable by reacting, at high temperatures in the presence of water,
(i) a compound of formula 1 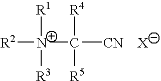 with; (ii) an alkali or ammonium salt of an alkyl sulphonate, paraffin sulphonate, aryl sulphonate, primary alcohol sulphate or fatty acid alkyl carboxylate or the respective acids or their substituted derivatives.

The invention relates to the use of bleach activator compounds in dishwasher detergent compositions.

Inorganic peroxy compounds, in particular percarbonate and perborate, which release hydrogen peroxide when dissolved in water, have long been used as disinfectant and bleach additives in detergent compositions such as dishwasher detergents. The oxidation effect of these substances in diluted solutions is largely dependent on temperature. Very often, oxidation cannot be obtained except at high temperatures, e.g. in excess of about 80° C.

By adding compounds which can be described as bleach activators, oxidation can be achieved at lower temperatures. Many types of bleach activator are known from the prior art and primarily include N- or O-acyl compounds, for example tetraacetyl ethylene diamine (TAED). However, as always, there is a need to develop other, alternative bleach activators with specific properties, particularly in applications involving dishwasher compositions, which essentially consist in bleaching coloured soil on crockery, such as tea stains.

A group of cationic ammonium nitrites and their use as bleach activators is known from EP-B-464,880. The use of compounds of this type in dishwasher detergent compositions is described in particular in WO 98/23719.

The ammonium nitrile compounds known to date dissolve very rapidly in water, are hygroscopic and are extremely reactive. In alkaline detergent formulations, therefore, even the smallest quantities of water can induce rapid hydrolysis and thereby de-activate the bleach activator. Particularly in certain types of dishwashers, in which the detergent comes into contact with water even before it is actually used (e.g. in the dispenser compartment), these properties lead to premature chemical reactions which reduce or even eliminate the effectiveness of the bleach activator.

EP-A-464,880 describes how the hygroscopic nature of ammonium nitrites is affected by the nature and size of anions. Ammonium nitrites with alkyl or paraffin sulphonate, aryl sulphonate, primary alcohol sulphate, for example lauryl sulphate or fatty acid alkyl carboxylate, as counter ions, are more stable than ammonium nitrites with conventional anions such as chloride, nitrite or methyl sulphate. The specification teaches that ammonium nitrites with RSO₃⁻, RSO₄⁻ or RCO₂⁻ as counter ions can be obtained by anionic exchange using ammonium nitrite with chloride or methyl sulphate as a counter ion. This being the case, the ammonium nitrite chloride or methyl sulphate is dissolved in methanol/isopropyl alcohol and the corresponding ammonium nitrite precipitated out by adding the sodium salt of a sulphonate, sulphate or carboxylate. Alternatively, a dry mixture of the ammonium nitrite having conventional anions with a sodium salt of a sulphonate, sulphate or carboxylate is proposed, in which case no actual anion exchange takes place and the resultant product is sticky and only moderately stable.

An anion exchange by means of a precipitation reaction in polar organic solvents, such as methanol and isopropanol, has disadvantages on ecological and economic grounds; separating the solvent from the precipitation product is difficult.

Accordingly, the underlying objective of the invention is to develop dishwasher detergent compositions using ammonium nitrites which are stable in terms of hydrolysis and release the bleach activator with a sufficient delay and continuously. At the same time, solubility should still be sufficient to ensure rapid availability in the main washing cycle of a dishwasher programme.

The present invention accordingly provides the use of a composition as a bleach activator in a dishwasher detergent composition, said composition being obtainable by reacting, at a high temperature in the presence of water:
(i) a compound of formula 1. 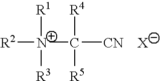
   wherein:
R¹, R², R³ are the same or different and are linear or branched C₁-C₂₄-alkyl groups, C₂-C₂₄-alkenyl groups or C₁-C₄-alkoxy-C₁-C₄-alkyl groups, substituted or unsubstituted benzyl(preferably unsubstituted), or R¹ and R², in conjunction with the nitrogen atom to which they are bonded, form a ring having 4 to 6 C-atoms, which ring can contain in addition to the nitrogen atom and instead of carbon atoms, one or two oxygen or nitrogen atoms, which ring can be unsubstituted or substituted (preferably unsubstituted) with one or more C₁-C₅-alkyl, C₁-C₅-alkoxy, C₁-C₅-alkanoyl, phenyl, amino, ammonium, cyano, cyanamino, chlorine, bromine, a N—R⁶ group or a R³—N—R⁶ group, in which R⁶ is hydrogen, C₁-C₅-alkyl, C₂-C₅-alkenyl, C₂-C₅-alkynyl, phenyl, C₇-C₉-aralkyl, C₅-C₇-cycloalkyl, C₁-C₆-alkanoyl, cyanomethyl or cyanide;
R⁴ and R⁵ are the same or different and are hydrogen, C₁-C₄-alkyl, C₁-C₄-alkenyl, C₁-C₄-alkoxy-C₁-C₄-alkyl, phenyl or C₁-C₃-alkylphenyl, preferably hydrogen, methyl or phenyl, wherein in particular R⁴ is hydrogen if R⁵ is not hydrogen; and
X⁻ is an anion; with
(ii) an alkali (for example an alkali metal) or ammonium salt of an alkyl sulphonate, paraffin sulphonate, aryl sulphonate, primary alcohol sulphate or fatty acid alkyl carboxylate or the respective acids or their substituted derivatives.

By “high temperature”, is meant, for example, at least 30° C., 40° C., 50° C., 60° C., or even 70° C.

X⁻ is preferably chloride, bromide, iodide, fluoride, sulphate, hydrogen sulphate, carbonate, hydrogen carbonate, phosphate, mono- or di-hydrogen phosphate, pyrophosphate, metaphosphate, nitrate, methyl sulphate, phosphonate, methyl phosphonate, methyl sulphonate or ethyl sulphonate.

By preference, an ammonium nitrile of formula 1 is reacted with an alkali or ammonium salt of an alkyl sulphonate, paraffin sulphonate, aryl sulphonate, primary alkyl sulphonate or fatty acid alkyl carboxylate or the respective acids or their substituted derivatives during the manufacturing process.

By particular preference, the ammonium nitrile of formula 1 and the alkali or ammonium salt of an alkyl sulphonate, paraffin sulphonate, aryl sulphonate, primary alkyl sulphonate or fatty acid alkyl carboxylate or the respective acids or their substituted derivatives are used in an equal molar ratio or with an excess of the alkali or ammonium salt, especially during the manufacturing process.

By particular preference, the ammonium nitrile of formula 1 is reacted with an alkali or ammonium salt of compounds of formula RSO₃⁻, wherein R is an aryl residue with at least one side chain consisting of no more than 12 carbon atoms.

By more particular preference, a compound of formula 1, in which R¹, R² and R³ are methyl groups and R and R are hydrogen atoms, is reacted with an alkali or ammonium salt of cumene sulphonate.

The alkali or ammonium salt is preferably used in excess quantities in the manufacturing process.

The composition may, for example, be in the form of a co-granulate which may, for example, additionally be coated with a coating substance.

The coating substance is preferably a polymer, wax, silicone or similar.

Surprisingly, it has been found that the anion exchange of conventional anions needed to reduce sensitivity to hydrolysis, hygroscopicity and de-activation of the ammonium nitrile, for example chloride or methyl sulphate for alkyl or paraffin sulphonate, aryl sulphonate, primary alcohol sulphate, for example lauryl sulphate or fatty acid alkyl carboxylate, need not take place within strict limits but may simply be effected by producing a homogeneous mixture in water with a statistical anion distribution, in particular such that ammonium nitrile of formula 1 is dissolved in water, for example, at 60 to 70° C., preferably until saturation and mixed with an aqueous solution, preferably saturated at for example, 60 to 70° C., of alkali or ammonium salts or the respective acids or their substituted derivatives of alkyl or paraffin sulphonates, aryl sulphonates, primary alcohol sulphates, for example lauryl sulphate or fatty acid alkyl carboxylates. The ammonium nitrile sulphonates, sulphates or carboxylates, which are not as readily soluble as the starting salts, can be obtained by precipitation or spray drying to produce white solid substances.

Alternatively, the anion exchange can be produced using a dry mixture of ammonium nitrile-chloride or methosulphates and alkali or ammonium salts of alkyl or paraffin sulphonates, aryl sulphonates, primary alcohol sulphates or fatty acid alkyl carboxylate or the respective acids or their substituted derivatives, adding water and homogenising by mixing, kneading and dispersing the pasty mixture, followed by drying.

The ammonium nitrites proposed by the invention are manufactured by means of an exchange of the anions of the ammonium nitrites of formula 1 for alkyl or paraffin sulphonates, aryl sulphate, primary alcohol sulphates or fatty acid carboxylate in the presence of water, the ammonium nitrites of formula 1 preferably being dissolved in water at 50 to 80° C., more preferably 60 to 70° C., especially to saturation point and mixed with an aqueous solution, preferably saturated at, for example, 50 to 80° C., preferably 60 to 70° C., of alkali or ammonium salts of alkyl or paraffin sulphonates, aryl sulphonates, primary alcohol sulphates or the respective acids or their substituted derivatives, for example lauryl sulphate or cumene sulphonate.

The molar ratio of the alkali or ammonium salts of an alkyl sulphonate, paraffin sulphonate, aryl sulphonate, primary alcohol sulphate or fatty acid alkyl carboxylate or the respective acids or their substituted derivatives and the ammonium nitrites of formula 1 is generally 1:2 to 5:1, preferably 1:1 to 4:1.

In a preferred embodiment, a clear, 40% aqueous solution of sodium cumene sulphonate and/or sodium lauryl sulphonate is mixed with a clear, 50 to 80% aqueous solution of cyanomethyl trimethyl ammonium methyl sulphate and/or chloride at 60 to 70° C., the molar ratio of sodium cumene sulphonate or lauryl sulphate to ammonium nitrile chloride or methyl sulphate being 1:1 to 2:1.

The ammonium nitrile sulphonates, sulphates or carboxylates, which are not as readily soluble as the starting salts, crystallise at temperatures in the range of 40° C. to 0° C., preferably at approximately 20° C., and can be filtered off or optionally recrystallised and dried.

Alternatively, the above-mentioned solution can be dried in a spraying tower. The resultant white, powdered solid consists of ammonium nitrile sulphonates or sulphates or carboxylates, the starting compounds and alkali/ammonium chloride or methyl sulphate.

In a third variant, the anion exchange can be produced by means of a dry mixture of the ammonium nitrites of formula 1, in particular ammonium nitrile chloride or methyl sulphate and the alkali or ammonium salts of alkyl or paraffin sulphonates, aryl sulphonates, primary alcohol sulphates or fatty acid alkyl carboxylates or the respective acids or their substituted derivatives in a molar ratio of 1:2 to 5:1, preferably 1:1 to 4:1, adding water and homogenising by mixing, kneading and dispersing the pasty mixture followed by drying.

The ammonium nitrites produced in the manner described above are characterized by a significant reduction in hygroscopicity and the speed at which they dissolve in aqueous media. When used in formulations for dishwasher detergents, compositions of this type exhibit significantly better bleaching performance than the known ammonium nitriles, even if they come into contact with moisture before the application itself.

Ammonium nitrites of formula 2 are more especially preferred as bleach activators in washing and detergent compositions 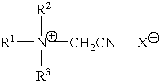
wherein R¹, R² and R³ are the same or different and are a linear or branched, saturated or unsaturated alkyl group with 1 to 24 carbon atoms, for example 2 to 24 carbon atoms, or substituted or unsubstituted benzyl and X⁻ is alkyl or paraffin sulphonate, aryl sulphonate, primary alcohol sulphate or fatty acid alkyl carboxylate, more especially cumene sulphonate and C_{12/14}-alcohol sulphate or mixtures of the components.

In order to ensure adequate stability in storage and guarantee that the bleach-activating effect is triggered during the washing cycle, it is of advantage if the ammonium nitrites proposed by the invention are used in granular form.

The ammonium nitrites produced as proposed by the invention, with or without a binding agent, may be compressed, compacted and carefully ground to granule sizes of, for example, from 200 to 1600 μm.

Another suitable granulation process is that using a mixer, for example a ploughshare mixer, ring film mixer or intensive mixer with the addition of a binder, in particular a water-free binding system, for example a fatty alcohol polyglycol ether.

In another embodiment, the moist filter cake or the product of the precipitation reaction described above may be put through a forming and granulation process without adding a binder, by means of extrusion dies or alternatively by annular pug presses or pug mills, optionally with a downstream rounding machine.

Similarly, the dried solid substance from the precipitation reaction or the dried powder obtained from the spray drying process described above may be granulated.

A fluidized bed granulation process using an aqueous solution of the mixed salts of ammonium nitrites produced by the anion exchange described above may also be considered.

Surprisingly, it has been found that an almost quantitative protection of the bleach activator substance can be achieved, in particular by co-granulating with cumene sulphonate, as also with other alkali or ammonium salts of an alkyl sulphonate, paraffin sulphonate, aryl sulphonate, primary alcohol sulphate or fatty acid alkyl carboxylate or the respective acids or their substituted derivatives. Without wishing to be bound by this theory, it is assumed that as part of the new type of manufacturing method, an extensive anion exchange takes place between the cumene sulphonate and the ammonium nitrile. Furthermore, excess cumene sulphonate forms which, being present in the preferred embodiments, possibly coats the resultant particles and leads to an unexpected significant increase in the stability of the bleach activator in the detergent composition during storage.

Another advantage of using cumene sulphonate in the co-granulate is its very good capacity to re-dissolve in water as compared with compounds such as fatty acids, silicone, waxes, etc., which have been used for this purpose until now and which can easily separate from an aqueous washing phase and stick to surfaces.

Dishwasher tablets made using the new type of ammonium nitrile compound also exhibit better solubility than tablets formulated using conventional bleach activator substances or granulates but otherwise made in the same way.

It may also be of advantage to coat the granulated ammonium nitrile salts as proposed by the invention with coating substances.

Appropriate coating materials are all film-forming substances such as waxes, silicones, fatty acids, soaps, anionic surfactants, non-ionic surfactants, cationic surfactants a well as anionic and cationic polymers, e.g. polyacrylic acids. Amongst other things, using these coating materials enables the dissolving behaviour to be delayed, which will also prevent interactions between the bleach activator and the enzyme system at the start of the washing process. Waxes with melting points of from 40 to 50° C. are primarily suitable for the specific application of dishwasher detergents.

Acid coating materials increase the storage stability of granulates in highly alkaline formulations containing percarbonate.

As a rule, the coating materials are applied by spraying the coating materials, either molten or dissolved in a solvent. For the purposes of the invention, the coating material is applied to the granular base in quantities of from 0-20%, preferably 1-10% by weight, based on the total weight.

The activator compounds proposed by the invention may be used in dishwasher detergent compositions either alone or in conjunction with other bleach activators known from the prior art (e.g. TAED) and/or bleach catalysts.

The advantageous properties of the new type of ammonium nitrile bleach activator compounds in detergent formulations are described in the Examples given below.

### EXAMPLES

The compounds used for the following tests were made by the co-granulation method described above.

Powdered detergent formulations of the following compositions were used to test the properties of the co-granulate proposed by the invention:

| | Example | Example | Example | Example | Example |
|---|---|---|---|---|---|
| | 1 | 2 | 3 | 4 | 5 |
| | % | % | % | % | % |
| CYMAS | 0.000 | 0.500 | 0.000 | 0.000 | 0.000 |
| CYMACl—NaCu (1:1) | 0.000 | 0.000 | 0.849 | 0.000 | 0.000 |
| CYMACl—NaCu (1:2) | 0.000 | 0.000 | 0.000 | 1.377 | 0.000 |
| CYMACl—NaCu (1:3) | 0.000 | 0.000 | 0.000 | 0.000 | 1.906 |
| Disilicate | 2.700 | 2.700 | 2.700 | 2.700 | 2.700 |
| Sodium tripolyphosphate | 32.000 | 32.000 | 32.000 | 32.000 | 32.000 |
| Sodium carbonate | 37.550 | 37.550 | 37.550 | 37.550 | 37.550 |
| Polymer | 4.100 | 4.100 | 4.100 | 4.100 | 4.100 |
| Sodium sulphate | 16.500 | 16.000 | 15.651 | 15.123 | 14.594 |
| Sodium percarbonate | 4.000 | 4.000 | 4.000 | 4.000 | 4.000 |
| Enzymes | 2.000 | 2.000 | 2.000 | 2.000 | 2.000 |
| Non-ionic surfactants | 0.850 | 0.850 | 0.850 | 0.850 | 0.850 |
| Silver corrosion inhibitor | 0.150 | 0.150 | 0.150 | 0.150 | 0.150 |
| Perfumes | 0.150 | 0.150 | 0.150 | 0.150 | 0.150 |
| Total | 100 | 100 | 100 | 100 | 100 |

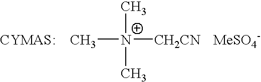

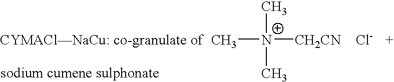

Figures in Brackets: Molar Composition of the Co-Granulate (CYMACl: Sodium Cumene Sulphonate)

The powdered detergent formulations given in Examples 1 to 5 were tested in a dose of 40 g using a Bosch® dishwasher machine, type 5062, Universal cleaning programme 50° C., water hardness 9° dH, heavily soiled in accordance with the IKW method (IKW-Arbeitskreis Maschinenspülmittel, “Methoden zur Bestimmung der Reinigungsleistung von maschinellen Geschirrspülmitteln (Part A and B)”, SÖFW, 11+14, 1998) and loaded as specified by the IKW method. The test samples used were 8 tea cups standardised to comply with the IKW method and soiled with tea stains. In the field of dishwasher detergents, tea stains are conventionally used as an indicator of bleaching performance. The tea-stained tea cups were placed in the top rack of the dishwasher and washed under the conditions described above.

The dishwasher detergent compositions of Examples 1 to 5 were dispensed from the dispenser compartment of the dishwasher. Because of its structure, the dispenser system of the dishwasher machine used did not afford sufficient protection in the closed state to prevent moisture or water from getting in. In addition, the dishwasher detergent composition given in Example 2 was rigorously tested in that the basic formulation was dispensed from the dispenser compartment without any ammonium nitrile whilst the ammonium nitrile itself was manually added to the washing liquid as the dispenser compartment opened.

Removal of the tea stains was then marked from visual observation in accordance with the IKW method on a scale of 0 (=unchanged very strong staining) to 10 (=no staining).

The results are set out in the table below:

| | | | | 4 | 5 | 6 |
|---|---|---|---|---|---|---|
| | | | 3 | CYMACl- | CYMACl- | CYMACl- |
| | 1 | 2 | No | NaCu | NaCu | NaCu |
| | CYMAS | CYMAS | activator | 1:1 | 1:2 | 1:3 |
| Test | manual | DC | DC | DC | DC | DC |
| soiling | (Ex. 2) | (Ex. 2) | (Ex. 1) | (Ex. 3) | (Ex. 4) | (Ex. 5) |
| Tea | 9.3 | 6.8 | 6.8 | 8.8 | 9.1 | 9.2 |
| stain | | | | | | |

CYMACl-NaCu = Co-granulate;
DC = dispenser compartment;
manual = dispensed after the preliminary washing cycle

By comparing the first two columns of the table, it may be seen that adding the nitrile element known from the prior art produces very good results when dispensed manually after the preliminary washing cycle (column 1) but has virtually no effect if dispensed from the dispenser compartment, i.e. prematurely comes into contact with water (column 2), which becomes particularly evident when compared with column 3, which gives the bleaching results obtained without bleach activator.

If the co-granulate proposed by the invention is used, significantly improved results are obtained when dispensing from the dispenser compartment and these compare favourably with the very good results obtained by dispensing the active substance manually after the preliminary washing cycle. It is clear from a comparison of columns 4, 5 and 6 that excess cumene sulphonate is produced for the reasons explained above, giving better results than a 1:1 ratio of ammonium nitrile and cumene sulphonate.

The features disclosed in the description given above and in the claims may essentially be used individually and in any combination to implement the invention in its different embodiments.

1. Use of a composition as a bleach activator in a dishwasher detergent composition, said composition being obtained by reacting, at high temperatures in the presence of water,
(i) a compound of formula 1 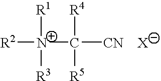
wherein:
R¹, R², R³ are the same or different and are linear or branched C₁-C₂₄-alkyl groups, C₂-C₂₄-alkenyl groups or C₁-C₄-alkoxy-C₁-C₄-alkyl groups, substituted or un-substituted benzyl(preferably unsubstituted), or R¹ and R², in conjunction with the nitrogen atom to which they are bonded, form a ring having 4 to 6 C-atoms, which ring can contain in addition to the nitrogen atom and instead of carbon atoms, one or two oxygen or nitrogen atoms, which ring can be unsubstituted or substituted (preferably unsubstituted) with one or more C₁-C₅-alkyl, C₁-C₅-alkoxy, C₁-C₅-alkanoyl, phenyl, amino, ammonium, cyano, cyanamino, chlorine, bromine, a N—R⁶ group or a R³—N—R⁶ group, in which R⁶ is hydrogen, C₁-C₅-alkyl, C₂-C₅-alkenyl, C₂-C₅-alkynyl, phenyl, C₇-C₉-aralkyl, C₅-C₇-cycloalkyl, C₁-C₆-alkanoyl, cyanomethyl or cyanide;
R⁴ and R⁵ are the same or different and are hydrogen, C₁-C₄-alkyl, C₁-C₄-alkenyl, C₁-C₄-alkoxy-C₁-C₄-alkyl, phenyl or C₁-C₃-alkylphenyl; and
X⁻ is an anion; with
(ii) an alkali or ammonium salt of an alkyl sulphonate, paraffin sulphonate, aryl sulphonate, primary alcohol sulphate or fatty acid alkyl carboxylate or the respective acids or their substituted derivatives.

2. Use according to claim 1 which at least one of R⁴ and R⁵, which are the same or different, is hydrogen, methyl or phenyl.

3. Use according to claim 1 or 2 wherein R⁴ is hydrogen and R⁵ is other than hydrogen.

4. Use according to any one of the preceding claims in which X⁻ is chloride, bromide, iodide, fluoride, sulphate, hydrogen sulphate, carbonate, hydrogen carbonate, phosphate, mono- or di-hydrogen phosphate, pyrophosphate, metaphosphate, nitrate, methyl sulphate, phosphonate, methyl phosphonate, methyl sulphonate or ethyl sulphonate.

5. Use according to any one of the preceding claims wherein the ammonium nitrile of formula 1 and the alkali or ammonium salt or acid or derivative thereof are used in the manufacturing process in an equal molar ratio or with an excess of the alkali or ammonium salt or acid derivatives thereof.

6. Use according to any one of the preceding claims wherein the alkali or ammonium salt of an aryl sulphonate or the respective acid or derivative has at least one side chain consisting of not more than 12 carbon atoms.

7. Use according to any one of the preceding claims wherein a compound of formula 1, in which R¹, R² and R³ are methyl groups and R⁴ and R⁵ are hydrogen atoms, is reacted with an alkali or ammonium salt of cumene sulphonate.

8. Use according to any one of the preceding claims wherein an excess of the alkali or ammonium salt is used in the manufacturing process.

9. Use according to any one of the preceding claims wherein the composition in the form of a co-granulate which is coated with a coating substance.

10. Use according to claim 9 wherein the coating substance is a polymer, wax, silicone or similar.

11. Use according to any one of the preceding claims wherein the bleach activator is made by cover spraying an aqueous solution of the compound of formula 1 with an aqueous solution of the alkali or ammonium salt or acid or derivatives thereof, after which the resultant particles are dried.

12. Use according to any one of the preceding claims wherein the dishwasher detergent composition is in the form of a dishwasher tablet.

13. Use according to any one of the preceding claims wherein the dishwasher detergent composition is particulate.

14. A method of cleaning crockery or cutlery using a detergent formulation comprising a bleach activator compound as defined in any one of the preceding claims, wherein, during the course of the method, the detergent formulation comes into contact with moisture or water at a point in time prior to dispensing the detergent formulation into the environment in which the cleaning process takes place.

15. A method according to claim 14 which takes place in a domestic dishwashing machine, which the detergent formulation is placed in a dispenser compartment of the machine and comes into contact with moisture or water before the dispenser compartment opens and dispenses the formulation into the environment in which the cleaning process takes place.

16. A dishwasher detergent composition comprising a bleach activator as defined in any one of the preceding claims 1 to 11 and a bleach.
